(19) United States
(12) Patent Application Publication
(10) Pub. No.: US 2023/0325496 A1
(43) Pub. Date: Oct. 12, 2023

(54) SYSTEM AND METHOD FOR TRANSITIONAL ISOLATION OF APPLICATIONS USING A WORKSPACE ENVIRONMENT

(71) Applicant: Dell Products, L.P., Round Rock, TX (US)

(72) Inventors: Vivekanandh Narayanasamy Rajagopalan, Bangalore (IN); Srinivasa Ragavan, Bangalore (IN)

(73) Assignee: Dell Products, L.P., Round Rock, TX (US)

(21) Appl. No.: 17/718,530

(22) Filed: Apr. 12, 2022

(51) Int. Cl. G06F 21/55; G06F 21/54; G06F 21/53; G06F 21/31

(52) U.S. Cl. CPC G06F 21/554; G06F 21/54; G06F 21/53; G06F 21/31

(57) ABSTRACT

Systems and methods for transitional isolation of applications using a workspace environment are described. The system for managing workspaces includes computer-executable instructions to determine whether the application is included in a list of approved applications, and when the application is not included in the list, generate an isolated workspace and deploy the application in the isolated workspace. The system may then provide the isolated workspace that has been deployed with the application for use by the user.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The introduction of the Internet as a network of distributed IHSs has made a significant contribution towards the advancement of computing capabilities. The speed and throughput capabilities available through the Internet have enhanced business practices as they are conducted today. Unfortunately, the computing capabilities afforded by the Internet have also provided an impetus for malicious activities. For example, identity theft and fraud over the Internet have increased dramatically. Also, other undesirable activities facilitated by the Internet include the transfer of malware, such as viruses, trojan horses, spam, worms, spyware, adware, and the like.

IHSs are continually threatened by a risk of attack from malicious applications, particularly that which can be downloaded and installed (e.g., deployed) on the IHS from the Internet. Malicious applications generally refer to those that can perform certain activities without a user's knowledge and without the user's consent. Malicious applications can infect a computer in a number of ways. Malicious code can be transmitted to the computer connected to the network as an executable program, for example in an attachment to an electronic message.

Computer security programs, such as antivirus software, can be installed on computers in an attempt to alleviate malicious code attacks. For example, antivirus-scanning software scans computer files, including electronic message attachments and electronic messages, to detect the presence of malicious code. However, in order for this antivirus software to be effective in protecting a computer it must first be successfully installed on the computer without interference. Additionally, the malicious applications may have been designed to circumvent the detection mechanisms of the antivirus software, thus yielding it inept at thwarting malicious activities. It is with these concerns in mind that embodiments of the present disclosure are presented herein.

### SUMMARY

To be included with language that follows the scope of the claims when the application is to be prepared for filing.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram of examples of components of an Information Handling System (IHS) that may be used to provide an application transitional isolation system according to one embodiment of the present disclosure.

FIG. 2 is a diagram of an example application transitional isolation system according to one embodiment of the present disclosure.

FIG. 3 illustrates a workspace type table that stores information associated with several types of workspaces that may be maintained by the system for providing isolation for new applications according to one embodiment of the present disclosure.

FIG. 4 illustrates an example application tracking table that may be maintained by the system for tracking new applications used by the application transitional isolation system according to one embodiment of the present disclosure.

FIG. 5 illustrates an example flow diagram depicting an application transitional isolation method that may be performed to isolate new applications according to one embodiment of the present disclosure.

FIG. 6 illustrates an example workspace migration method that may be performed to migrate the new application to its respective workspace according to one embodiment of the present disclosure.

### DETAILED DESCRIPTION

Embodiments of the present disclosure provide a system and method for transitional isolation of applications using a workspace environment. Whereas traditional approaches to malware containment and remediation has been limited to computer security programs, such as antivirus software, such tools still possess certain deficiencies in that malicious code can circumvent malware detection mechanisms incorporated by these computer security programs. Embodiments of the present disclosure provide a solution to this problem, among others, using a system that isolates newly deployed (e.g., installed) applications in an isolated workspace so that it can be monitored over a period of time to ensure any deleterious effects caused by any potential malware in the application are effectively quarantined from the rest of the Information Handling System (IHS). If the application has been found to be free from malware (e.g., following the quarantine period), the system automatically migrates the application to its primary workspace in a manner that is seamless to the user.

IHSs provide users with capabilities for accessing, creating, and manipulating data. IHSs often implement a variety of security protocols in order to protect this data during such operations. A known technique for securing access to protected data that is accessed via an IHS is to segregate the protected data within an isolated software environment that operates on the IHS, where such isolated software environments may be referred to by various names, such as virtual machines, containers, dockers, etc. Various types of such segregated environments are isolated by providing varying degrees of abstraction from the underlying hardware and from the operating system of the IHS. These virtualized environments typically allow a user to access only data and applications that have been approved for use within that particular isolated environment. In enforcing the isolation of a virtualized environment, applications that operate within such isolated environments may have limited access to capabilities that are supported by the hardware and operating system of the IHS.

Currently implemented IHSs used by consumers may be configured with workspaces, such as software-based workspaces (e.g., docker), hardware-based workspaces (e.g., virtualBox, VMWare, etc.), and cloud-based workspaces. To meet this demand, many computing devices (e.g., IHSs) are now being provided with workspace orchestrators that manage how the workspaces are used in the IHS. Such workspace orchestrators involve the concepts of orchestration, optimization of the IHS, and composition for Operating System (OS) and System-On-Chip (SOC) agnostic User Interface (UI)/User Experience (UX) features for modern clients, while preserving key parts of the traditional client experience (e.g., do-no-harm). The workspace orchestrator provides workload orchestration with concurrent workspaces of varying performance and security levels running on the IHS as well as in the cloud. The workspaces may be implemented using various container technologies.

For these workspace orchestrators, most or all applications, with the exception of certain low level OS or vendor services, may be executed inside of a workspace for better security and scalability purposes. The workspaces can be implemented using software isolation techniques, such as Docker, Snap, and the like or using hardware isolation methods like Hyper-V docker, lightweight VMs (e.g., Photon-OS, IncludeOS, etc.) and full bare-metal-based VMs. A workspace generally refers to an isolated environment that can host one or more applications. A workspace host refers to software based (e.g., Docker) or hypervisor/hardware based (e.g., Kata container, VM, etc.) solutions to provide the isolated environments for the workspace orchestrator.

Nevertheless, with the widespread introduction of orchestrators, an Information Technology Decision Maker (ITDM) may need to define and/or deploy workspaces such that the end users can access them from any device. In this manner, the end users may have the flexibility of modifying a workspace and adding applications of their choice into the workspace without prior approval from the ITDM. The workspaces can be deployed with the following types, namely, web applications (apps) running inside a browser, native apps that are installed on the workspace (e.g., Win32, UWP Applications, etc.). IHS providers are currently focusing on providing secured workspaces to their customers and providing the flexibility to add applications to these workspaces. Nevertheless, this flexibility presents challenges of managing unapproved applications which can be less trusted, and isolating the un-approved applications from other processes used on the IHS.

A flexible workspace environment presents several challenges to the ITDM. No mechanism currently exists to notify and/or approve the installation of unauthorized applications by the end user on the IHS. Additionally, the static policy for blocking certain applications at the IHS (e.g., Windows Application Guard) requires continual updating. Also, no automatic mechanism exists to isolate the applications in the workspaces for a transitional period and bring it back to the primary workspace upon approval. For example, certain tools (e.g., Hyper-V, Windows Sandboxing, Firejail, etc.) may provide isolation, but this isolation is permanent in that manual intervention is required to revert the application to normal use following a trial period.

The end user is also presented with certain challenges. For example, current solutions only allow or disallow the addition of applications based on ITDM policy/settings that are often statically configured. This often results in permanent or longer periods of isolation, particularly when the isolated application is restricted from using certain features (e.g., peripherals) of the IHS, thus reducing productivity. Unless the end user is relatively savvy, such as an experienced user, migration of the application from the isolated workspace does include restoration of application artifacts and related configuration. That is, inexperienced users are often required to re-establish the application's configuration settings following migration from the isolated workspace. The end user wants to add an application to the workspace but may or may not be allowed based on the type of workspaces and the static permissions set by the ITDM.

To provide a particular use case, an ITDM designed and deployed workspace can be configured to be modifiable (e.g., can be added with applications) by the end user. For example, the ITDM may create the workspace with certain applications from an approved list of applications, and allow the end users to modify the workspace by adding additional applications of their choice. If the added application is not approved via the inclusion list, however, it must be installed in an isolated workspace. In such a scenario however, the application can be permanently isolated, and the ITDM has no way to approve the application and allow it to be migrated to the productive workspace.

In another particular use case, the end user creates a workspace on their own and adds applications that are not approved by the IT Administrator. For example, the user may generate a custom workspace and install custom applications (e.g., Cisco WebEx, WebEx Teams, etc.) in the custom workspace for collaboration with others. But in such a case, the application is configured as an isolated custom workspace, and may be unusable due to certain restrictions imposed by the ITDM for peripheral usage of custom workspaces.

In yet another particular use case, an ITDM designed and deployed non-modifiable workspace that is installed with applications that have been included in a list of applications, which has been approved by the organization such that the workspace is locked from any modification by the end user. Thus, the end user may not have any rights to modify the workspace by adding applications. This may not present security problems, but it can obviously be very restrictive.

Regarding the first two use cases presented above, when an added application is deployed in the workspace and used, it typically generates artifacts, such as user projects (e.g., Visual Studio Project content), user editor preferences, and any other application preferences. When the application has been approved, however, it should be brought back to the primary workspace along with its associated artifacts seamlessly. Such a scenario creates a need for a transitional isolation mechanism that allows the ITDM to approve the applications and enable end users to continue to use the workspaces such that, when the application has been approved, transition the applications seamlessly to a primary workspace. Without solving the above-mentioned problems, the ITDM needs to realign (remove/migrate) the workspaces to bring the application from the isolated workspace following approval. Also, the end user may require the technical expertise (i.e., increased complexity for end users) to manually migrate the applications and its related artifacts (e.g., application cache, data files, etc.) based on the realigned workspaces.

As will be described in detail herein below, embodiments of the present disclosure provide a system and method for transitional isolation of applications using a workspace environment that isolates newly deployed (e.g., installed) applications in a workspace so that it can be monitored over a period of time, such that when the application has been found to be free from malware, the system automatically migrates the application to the primary workspace in a manner that is seamless to the end user.

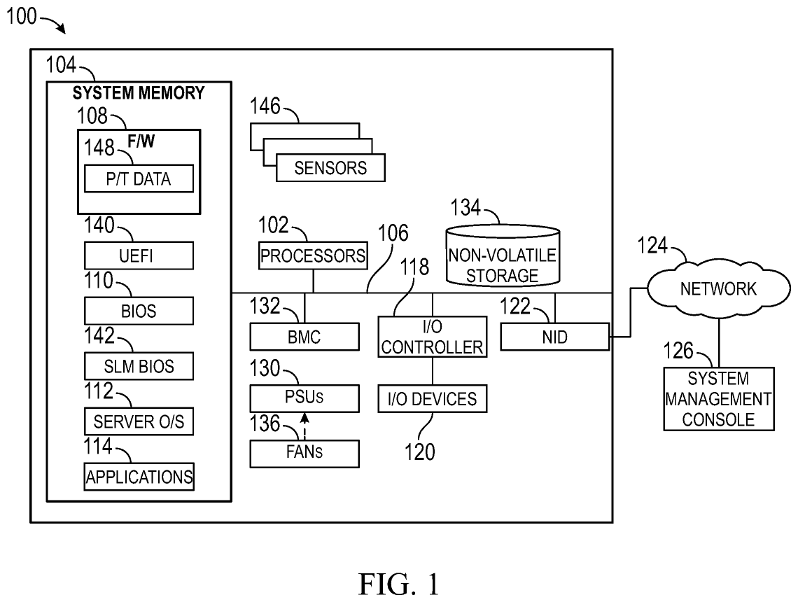

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail below. FIG. 1 shows various internal components of an IHS configured to implement certain of the described embodiments. It should be appreciated that although certain embodiments described herein may be discussed in the context of a personal computing device, other embodiments may utilize various other types of IHSs.

A suitable IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, science, control, or other purposes. For example, an IHS may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price.

The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components.

FIG. 1 is a block diagram of examples of components of an Information Handling System (IHS), according to some embodiments. Particularly, IHS 100 includes one or more processor(s) 102 coupled to system memory 104 via system interconnect 106. System interconnect 106 may include any suitable system bus. System memory 104 may include a plurality of software and/or firmware modules including firmware (F/W) 108, basic input/output system (BIOS) 110, operating system (O/S) 112, and/or application(s) 114. Software and/or firmware module(s) stored within system memory 104 may be loaded into processor(s) 102 and executed during operation of IHS 100.

F/W 108 may include a power/thermal profile data table 148 that is used to store power profile data and thermal profile data for certain hardware devices (e.g., processor(s) 102, system memory 104, non-volatile storage 134, NID 122, I/O controllers 118, etc.). System memory 104 may include a UEFI interface 140 and/or a SMBIOS interface 142 for accessing the BIOS as well as updating BIOS 110. In general, UEFI interface 140 provides a software interface between an operating system and BIOS 110. In many cases, UEFI interface 140 can support remote diagnostics and repair of computers, even with no operating system installed. SMBIOS interface 142 can be used to read management information produced by BIOS 110 of IHS 100. This feature can eliminate the need for the operating system to probe hardware directly to discover what devices are present in the computer.

IHS 100 includes one or more input/output (I/O) controllers 118 which manages the operation of one or more connected input/output (I/O) device(s) 120, such as a keyboard, mouse, touch screen, microphone, a monitor or display device, a camera, a microphone, audio speaker(s) (not shown), an optical reader, a universal serial bus (USB), a card reader, Personal Computer Memory Card International Association (PCMCIA) slot, and/or a high-definition multimedia interface (HDMI) which may be coupled to IHS 100.

IHS 100 includes Network Interface Device (NID) 122. NID 122 enables IHS 100 to communicate and/or interface with other devices, services, and components that are located externally to IHS 100. These devices, services, and components, such as a system management console 126, can interface with IHS 100 via an external network, such as network 124, which may include a local area network, wide area network, personal area network, the Internet, etc.

IHS 100 further includes one or more power supply units (PSUs) 130. PSUs 130 are coupled to a BMC 132 via an I2C bus. BMC 132 enables remote operation control of PSUs 130 and other components within IHS 100. PSUs 130 power the hardware devices of IHS 100 (e.g., processor(s) 102, system memory 104, non-volatile storage 134, NID 122, I/O controllers 118, PSUs 130, etc.). To assist with maintaining temperatures within specifications, an active cooling system, such as one or more fans 136 may be utilized.

IHS 100 further includes one or more sensors 146. Sensors 146 may, for instance, include a thermal sensor that is in thermal communication with certain hardware devices that generate relatively large amounts of heat, such as processors 102 or PSUs 130. Sensors 146 may also include voltage sensors that communicate signals to BMC 132 associated with, for example, an electrical voltage or current at an input line of PSU 130, and/or an electrical voltage or current at an output line of PSU 130.

BMC 132 may be configured to provide out-of-band management facilities for IHS 100. Management operations may be performed by BMC 132 even if IHS 100 is powered off, or powered down to a standby state. BMC 132 may include a processor, memory, and an out-of-band network interface separate from and physically isolated from an in-band network interface of IHS 100, and/or other embedded resources.

In certain embodiments, BMC 132 may include or may be part of a Remote Access Controller (e.g., a DELL Remote Access Controller (DRAC) or an Integrated DRAC (iDRAC)). In other embodiments, BMC 132 may include or may be an integral part of a Chassis Management Controller (CMC).

In many cases, the hardware devices configured on a typical IHS 100 are registered in its system BIOS. In such cases, BIOS 110 may be accessed to obtain the power/thermal profile data table 148 for those hardware devices registered in BIOS 110. For any non-registered (unsupported/unqualified) hardware device, however, its power profile and/or thermal profile may be unknown. In such situations, the server thermal control is often required to run in an open loop. That is, the thermal profile for the IHS 100 may be difficult, if not impossible, to optimize.

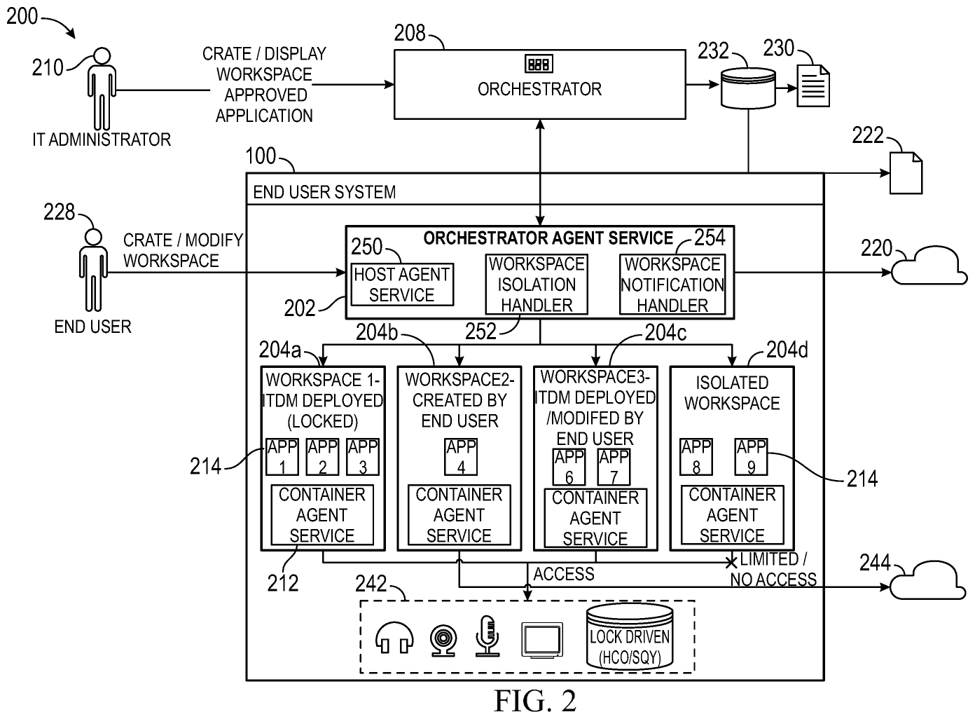

FIG. 2 is a diagram of an example application transitional isolation system 200 according to one embodiment of the present disclosure. The system 200 includes an IHS 100 that stores and executes an orchestrator agent service 202 that manages (e.g., generates, instantiates, deletes, modifies, etc.) one or more workspaces 204a-d (collectively 204) on an IHS 100. In the particular embodiment shown, workspaces 204a-c are primary workspaces, while workspace 204d is an isolated workspace. The orchestrator agent service 202 communicates with a workspace orchestrator 208 for coordinated management of the IHS 100 by an ITDM 210. For example, IHS 100 may be one of many IHSs deployed in an organization, such as a corporation, school, and the like, and the purpose of the ITDM 210 is to manage the operation of the IHSs 100 using the workspace orchestrator 208.

In a particular example, the orchestrator agent service 202 may include at least a portion of a hypervisor (e.g., VirtualBox, VMWare, etc.), which may be a type-1, native, or bare-metal hypervisor running directly on IHS 100, or it may include a type-2 or hosted hypervisor running on top of the host OS of the IHS 100. The workspaces 204a-d may be any type, such as software-based workspaces (e.g., docker, snap, Progressive Web App (PWA), INTEL Clear Container, etc.), or hardware-based workspaces (e.g., VMWare, VirtualBox, etc.).

Each workspace 204 is configured with a workspace agent service 212 and one or more applications 214. The workspaces 204 differ according to how they were created. Workspace 204a, for example, is a locked workspace in that no additional applications may be deployed on that workspace 204a after instantiation. As shown, workspace 204a is included with three applications 214 that have been established for that workspace type. Workspace 204b is a user-created workspace in that it has been generated by an end user 228 via the orchestrator agent service 202. That is, the end user 228 can create the workspace 204b and install any desired application based upon certain criteria as described in the present disclosure. The particular workspace 204b is shown as being deployed with a single application 214. Workspace 204c is an ITDM created workspace in that it has been created by the ITDM 210, and is allowed to be installed with any desired application 214 based upon certain criteria as described in the present disclosure. The particular workspace 204c is shown as being deployed with two applications 214. In general, workspaces 204a-c may be referred to as primary workspaces in that they generally comprise the principal locations where the end user 228 would like to operate the new applications 214′ in a normal productivity mode of operation.

The orchestrator agent service 202 includes a host agent service 250, a workspace isolation handler 252, and a workspace notification handler 254. The host agent service 250 provides access to the components of the IHS 100 by orchestrator 208. For example, the host agent service 250 may continually monitor any hypervisors configured in the IHS 100 to determine which workspaces 204a-d are being generated. The host agent service 250 may monitor certain components (e.g., speakers, earphones, microphones, monitors, monitor setting features, local drives, etc.) as well as one or more cloud services 244 that the IHS 100 may have access to.

The workspace isolation handler 252 manages the isolation of new applications 214′ on the IHS 100. For example, workspace isolation handler 252 may create and instantiate an isolated workspace 204d. The isolated workspace 204d may be instantiated whenever a new application 214 is to be operated in an isolated environment (e.g., quarantined) to ensure that the new application 214 causes no deleterious effects to the operation of the other workspace 204a-c. As shown, the isolated workspace 204d is shown storing and executing two applications 214′. For example, one application 214′ may be deployed in the isolated workspace 204d due to an attempt to deploy it in the user-created workspace 204b, while the other application 214′ is deployed in the isolated workspace 204d due to an attempt to deploy it in the ITDM created workspace 204c.

The workspace isolation handler 252 may, in response to user input from the end user 228, manage the instantiation of workspaces 204a-d on the IHS 100. In some cases, the workspace isolation handler 252 may communicate with a third party authentication service 220 (e.g., Okta, Azure AD, etc.) to ensure that the end user 228 possesses sufficient rights to install the workspaces 204a-d. Additionally, the workspace isolation handler 252 may maintain a workspace metadata file 222 that includes information (e.g., manifest) associated with some, most, or all workspaces 204 provisioned in the IHS 100 along with the names of the applications 214 installed on each workspace 204.

Whenever the workspace isolation handler 252 detects that a new application 214′ is attempted to be installed on a locked workspace 204a, it will inhibit the new application 214′ from being installed. According to one embodiment of the present disclosure, whenever the workspace isolation handler 252 detects that a new application 214′ is attempted to be installed on a workspace 204 that allows deployment of new workspaces, which is this particular embodiment, is the user-created workspace 204b and ITDM-created workspace 204c, it will check the new application 214′ against a list of approved applications 230 stored in a storage entity 232 (e.g., database) of the workspace orchestrator 208 and if a match is found, the new application 214′ will be deployed on the workspace 204b-c. If the new application 214′, however, is not included in the list of approved applications 230, it will instantiate the isolated workspace 204d if it has not already been done, and deploy the new application 214′ in the isolated workspace 204d.

When the new application 214′ is being run in the isolated workspace 204d, the workspace isolation handler 252 may restrict the new application 214′ from accessing certain components of the IHS 100. For example, the workspace isolation handler 252 may restrict the new application 214′ from accessing certain peripheral devices 242 (e.g., speakers, earphones, microphones, monitors, monitor setting features, local drives, etc.) as well as one or more cloud services 244 that the IHS 100 may have access to.

The workspace notification handler 254 may generate an approval request, and send the approval request to the ITDM 210 via the workspace orchestrator 208. Thus, the ITDM 210 may be made aware of the attempted deployment of the new application 214′ so that a decision may be made as to whether the new application 214′ will be approved for deployment on one of the primary workspace 204a-c.

The ITDM 210 may, or may not, approve the new application's deployment on its primary workspace 204a-c. If the new application 214′ is approved, the orchestrator agent service 202 may receive a response to the approval request indicating that approval is granted. Alternatively, the orchestrator agent service 202 may receive a rejection response indicating the approval will not be given, or in some cases, the orchestrator agent service 202 may not ever receive a response to the approval request. In one embodiment, if the new application 214′ is not approved, the new application 214′ may continue to be operated within the isolated workspace 204d indefinitely. That is, the non-approved new application 214′ may be continually executed only within the isolated workspace 204d. If, however, the new application 214′ is approved, the orchestrator agent service 202 may obtain one or more application artifacts from the isolated workspace, deploy the application on the primary workspace, and configure the application using the obtained artifacts on the primary workspace 204b-c.

The application artifacts generally refer to information that is generated by or otherwise stored in the isolated workspace 204d as a result of operating the new application 214′ in the isolated workspace 204d. Application artifacts may include, for example, output content (e.g., documents generated by a word processing type program, audio-video content generated by a multi-media type program, etc.), settings associated with the new program, and workspace variables that have been modified as a result of use of the new application 214′ in the isolated workspace 204d.

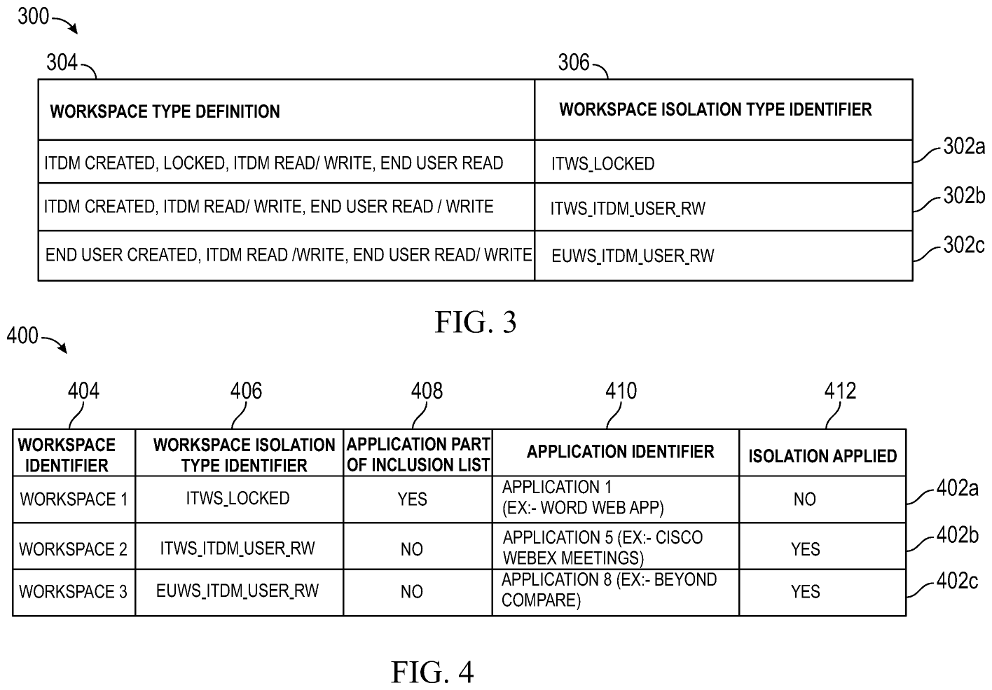

FIG. 3 illustrates a workspace type table 300 that stores information associated with several types of workspaces that may be maintained by the system 200 for providing isolation for new applications according to one embodiment of the present disclosure. Each row 302a-c represents a particular type of workspace that may be managed by the system 200 in which each row includes a first column for storing a definition 304 and a second column 306 for storing a workspace isolation type identifier (e.g., a tag) to be associated with each workspace generated on the IHS 100.

In particular, the first row 302a indicates that a workspace 204, which is locked, will be included with a tag named ‘ITWS_LOCKED’. Workspace 204a as shown and described above with reference to FIG. 2 may be included with such a tag. The second row 302b indicates that an ITDM-created workspace 204 will be included with a tag named ‘ITWS_ITDM_USER_RW’. Workspace 204b as shown and described above with reference to FIG. 2 may be included with such a tag. The third row 302c indicates that a user-created workspace 204 will be included with a tag named ‘EUWS_ITDM_USER_RW’. Workspace 204c as shown and described above with reference to FIG. 2 may be included with such a tag. Thus as shown, each workspace 204 deployed on the IHS 100 may be tagged with an indication of its type so that it can be managed by the system 200.

FIG. 4 illustrates an example application tracking table 400 that may be maintained by the system 200 for tracking new applications 214′ used by the application transitional isolation system according to one embodiment of the present disclosure. The table 400 includes multiple rows 402 in which each row represents a workspace 204 deployed on the IHS 100. The table 400 also includes multiple columns in which a first column 404 represents a workspace identifier associated with each workspace 204, and a second column 406 represents a workspace isolation type identifier, which for example, may be the workspace isolation type identifier as shown in FIG. 3. The table 400 may also include a third column 408 indicating whether an application identified in the fourth column 410 is included in the list of approved applications 230. The table 400 also includes a fifth column 412 representing whether isolation is to be applied to the application referenced in column 410.

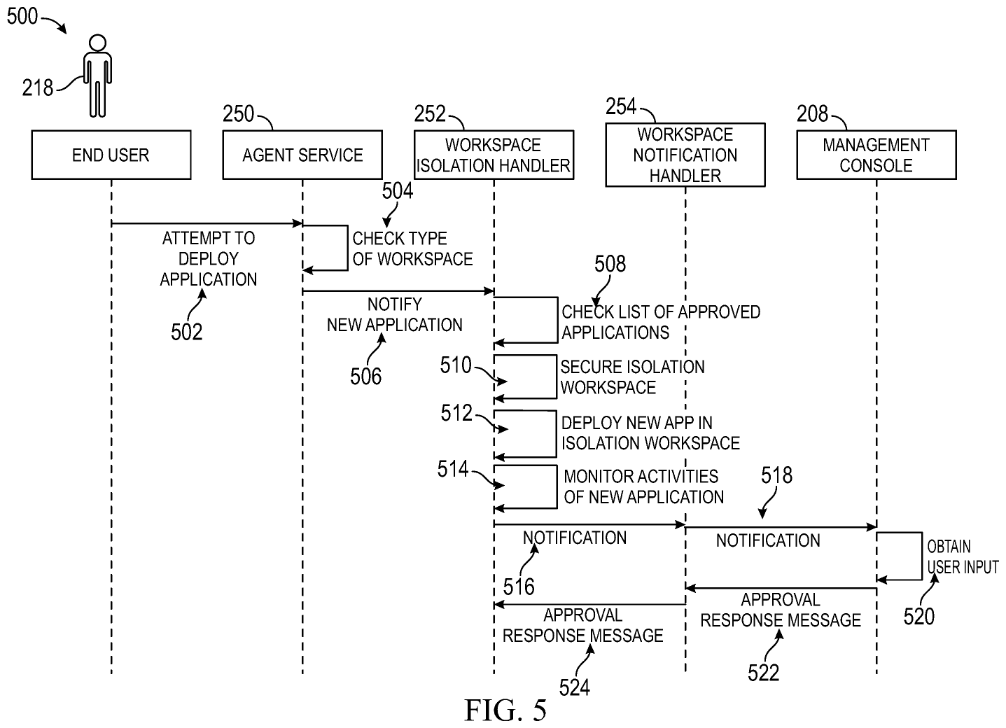

FIG. 5 illustrates an example flow diagram depicting an application transitional isolation method 500 that may be performed to isolate new applications according to one embodiment of the present disclosure. In one embodiment, some, most, or all steps described herein may be performed by the application transitional isolation system 200 as described above with reference to FIG. 2.

Initially at step 502, the host agent service 250 receives an indication that the end user 228 is attempting to deploy an application in a particular workspace 204. The host agent service 250 may be in communication with a suitable mechanism (e.g., hypervisor) that manages (e.g., generates, instantiates, deletes, etc.) workspaces. Alternatively, the host agent service 250 and/or orchestrator agent service 202 may form at least a portion of the mechanism that manages the workspaces. Thereafter at step 504, the host agent service 250 identifies the workspace isolation type identifier associated with the workspace 204 on which the application is being deployed. For example, the host agent service 250 may obtain the workspace isolation type identifier from the table 300 shown in FIG. 3. If the workspace is locked (e.g., workspace 204a of FIG. 2), the host agent service 250 inhibits the application from being deployed and the method 500 ends. If, however, the workspace is a user-created workspace 204b, or an ITDM-created workspace 204c that allows user modification, the host agent service 250 notifies the workspace isolation handler 252 that the new application is to undergo isolation at step 506.

At step 508, the workspace isolation handler 252 determines whether the new application is in the list of approved applications 230. That is, if the workspace is a user-created workspace (e.g., workspace 204b) or an ITDM-created workspace (e.g., workspace 204c) and the new application is included in the list of approved applications 230, the host agent service 250 allows deployment of the new application and the process ends. If, however, the new application is not in the list of approved applications 230 and it is being deployed on either a user-created workspace (e.g., workspace 204b) or an ITDM-created workspace (e.g., workspace 204c), the workspace isolation handler 252 secures an isolation workspace 204d at step 510. For example, the workspace isolation handler 252 may determine whether an isolation workspace 204d currently exists and if not, instantiate an isolation workspace 204d for quarantining the new application for a specified period of time. The workspace isolation handler 252 also deploys the new application in the isolation workspace 204d at step 512, and monitors the activities of the new application at step 514.

At step 516, the workspace isolation handler 252 communicates with the workspace notification handler 254 to provide notification of the attempted deployment. The workspace notification handler 254, in turn, forwards the notification message to the orchestrator 208 at step 518. At this point, the orchestrator 208 generates an indication to the ITDM 210 that an attempted deployment has occurred, and to request user input for approving or dis-approving of the deployment of the new application at step 520.

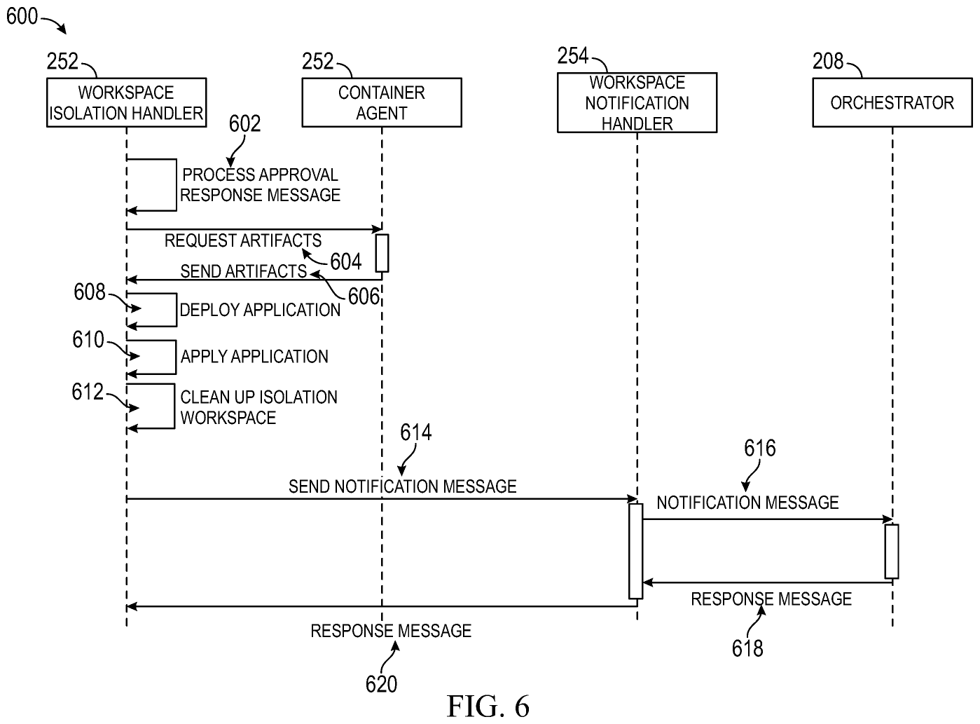

At step 522, the orchestrator 208 send an approval response message to the workspace notification handler 254, which in turn, forwards the approval response message to the workspace isolation handler 252 at step 524. If the deployment of the new application was not approved, the workspace isolation handler 252 may perform certain actions based upon the non-approval. For example, the workspace isolation handler 252 may leave the new application on the isolation workspace 204d in which it will be restricted to further operation. As another example, the workspace isolation handler 252 may remove the new application from the isolation workspace 204d and/or generate a notification message to the end user 228 that the new application has not been approved for use on the IHS 100. Nevertheless, if the new application has been approved for use on the IHS 100, the workspace migration method 600 as described below with reference to FIG. 6 may be performed.

FIG. 6 illustrates an example workspace migration method 600 that may be performed to migrate the new application to its respective workspace 204b-c according to one embodiment of the present disclosure. The workspace migration method 600 may be performed at any suitable time. In one embodiment, the workspace migration method 600 may be performed after the workspace isolation handler 252 receives an approval response message from the orchestrator 208, such as the approval response message received by the workspace isolation handler 252 in step 524 of FIG. 5. Additionally, some, most, or all steps described herein may be performed by the application transitional isolation system 200 as described above with reference to FIG. 2.

At step 602, the workspace isolation handler 252 processes the approval response message. The approval response message may include certain criteria associated with the approval of the new application. The criteria may include, for example, certain limitations to be applied to the new application, such as peripheral devices 242 that the new application is, or is not to be allowed to communicate with and/or maximum number of resources (e.g., computing capacity, storage capacity, networking capacity, etc.) that the new application will be allowed to use. The workspace isolation handler 252 processes the approval response message to identify such information, and apply the information to the deployment of the new application on the workspace 204b-c.

At step 604, the workspace isolation handler 252 sends a request message to the container agent service 212 associated with the isolation workspace 204d to obtain artifacts associated with the new application. The artifacts may include, for example, output content generated by new application, a configuration (e.g., settings) associated with the new program, workspace variables that have been modified as a result of use of the new application, and the like. Thereafter at step 606, the container agent service 212 associated with the isolation workspace 204d responds with the requested information.

At step 608, the workspace isolation handler 252 installs (e.g., deploys) the new application on the primary workspace 204b-c. In one embodiment, the workspace isolation handler 252 may identify the primary workspace that was the target of the new application, for example, by querying the application tracking table 400 to obtain its identity. The workspace isolation handler 252 then applies the artifacts obtained from the isolation workspace 204d in the primary workspace 204b-c at step 610, and cleans up the isolation workspace 204d at step 612. To clean up the isolation workspace 204d, for example, the workspace isolation handler 252 may un-install the new application from the isolation workspace 204d, and reset any registry data that was changed as a result of installing the new application, and erase any files generated by the new application on the isolation workspace 204d.

At step 614, the workspace isolation handler 252 sends a notification message to the workspace notification handler 254, that in turn, forwards the notification message to the orchestrator 208. Once the orchestrator 208 receives the notification message, it may generate an alert message, or other form of indication that the new application has been deployed on the primary workspace 204b-c. At step 618, the orchestrator 208 sends a response message to the workspace notification handler 254 that in turn, forwards the response message to the workspace isolation handler 252.

At this point, the application has been deployed on the primary workspace 204b-c and is available for use by the end user 228. Nevertheless, after performing step 620, the process ends.

While FIGS. 5 and 6 illustrate example methods 500, 600 that may be performed for temporarily quarantining a new application using an isolation workspace, the features of the methods 500, 600 may be embodied in other specific forms without deviating from the spirit and scope of the present disclosure. For example, either of the methods 500, 600 may perform additional, fewer, or different operations than those described in the present example. As another example, certain steps of the aforedescribed methods 500, 600 may be performed in a sequence different from that described above. As yet another example, certain steps of either of the methods 500, 600 may be performed by other components in the IHS 100 other than those described above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

What is claimed is:

1. An Information Handling System (IHS) comprising:
a processor; and
a memory coupled to the processor, the memory having program instructions stored thereon that, upon execution by the processor, cause the IHS to:
receive, from a user of the IHS, a request to deploy an application on a primary workspace;
determine whether the application is included in a list of approved applications;
when the application is not included in the list, generate an isolated workspace and deploy the application in the isolated workspace; and
provide the isolated workspace that has been deployed with the application for use by the user.

2. The IHS of claim 1, wherein the instructions are further executed to:
monitor one or more activities of the application for a specified period of time;
when the application has been determined to be approved for use after the specified period of time, obtain one or more application artifacts from the isolated workspace, deploy the application on the primary workspace, and configure the application using the obtained artifacts; and
provide the primary workspace that has been deployed with the application for use by the user.

3. The IHS of claim 1, wherein the instructions are further executed to restrict the application from using one or more peripheral devices of the IHS when executed from the isolated workspace.

4. The IHS of claim 1, wherein the instructions are further executed to:
detect that an attempt to deploy the application has been performed on the primary workspace;
determine whether the primary workspace is locked from being deployed with any new applications;
when the primary workspace has been determined to be locked, inhibit the application from being deployed on the primary workspace.

5. The IHS of claim 4, wherein the instructions are further executed to:
when the primary workspace is not locked from being deployed with new applications, send a request to approve deployment of the application to a workspace orchestrator that is executed to monitor one or more activities of the application for a specified period of time, and approve the application based on the monitored activities.

6. The IHS of claim 5, wherein the instructions are further executed to:
when the request is approved by the workspace orchestrator, deploy the application on the primary workspace.

7. The IHS of claim 5, wherein the instructions are further executed to:
when the request is not approved, allow further use of the application on the isolated workspace, and inhibit deployment of the application on the primary workspace.

8. The IHS of claim 1, wherein the instructions are further executed to, when the application is not included in the list, send a notification message to a workspace orchestrator.

9. An application transitional isolation method comprising:
receiving, from a user of an Information Handling System (IHS), a request to deploy an application on a primary workspace;
determining whether the application is included in a list of approved applications;
when the application is not included in the list, generating an isolated workspace and deploy the application in the isolated workspace; and
providing the isolated workspace that has been deployed with the application for use by the user;

10. The application transitional isolation method of claim 9, further comprising:
monitoring one or more activities of the application for a specified period of time;
when the application has been determined to be approved for use after the specified period of time, obtaining one or more application artifacts from the isolated workspace, deploying the application on the primary workspace, and configuring the application using the obtained artifacts; and
providing the primary workspace that has been deployed with the application for use by the user.

11. The application transitional isolation method of claim 9, further comprising restricting the application from using one or more peripheral devices of the IHS when executed from the isolated workspace.

12. The application transitional isolation method of claim 9, further comprising:
detecting that an attempt to deploy the application has been performed on the primary workspace;
determining whether the primary workspace is locked from being deployed with any new applications;
when the primary workspace has been determined to be locked, inhibiting the application from being deployed on the primary workspace.

13. The application transitional isolation method of claim 12, further comprising:
when the primary workspace is not locked from being deployed with new applications, sending a request to approve deployment of the application to a workspace orchestrator that is executed to monitor one or more activities of the application for a specified period of time, and approving the application based on the monitored activities.

14. The application transitional isolation method of claim 13, further comprising:
when the request is approved by the workspace orchestrator, deploying the application on the primary workspace.

15. The application transitional isolation method of claim 14, further comprising:
when the request is not approved, allowing further use of the application on the isolated workspace, and inhibiting deployment of the application on the primary workspace.

16. The application transitional isolation method of claim 9, further comprising, when the application is not included in the list, sending a notification message to a workspace orchestrator.

17. A hardware memory device having program instructions stored thereon that, upon execution by a processor of an Information Handling System (IHS), cause the IHS to:
receive, from a user of the IHS, a request to deploy an application on a primary workspace;
determine whether the application is included in a list of approved applications;
when the application is not included in the list, generate an isolated workspace and deploy the application in the isolated workspace; and
provide the isolated workspace that has been deployed with the application for use by the user;

18. The hardware memory device of claim 17, wherein the instructions are further executed to:
monitor one or more activities of the application for a specified period of time;
when the application has been determined to be approved for use after the specified period of time, obtain one or more application artifacts from the isolated workspace, deploy the application on the primary workspace, and configure the application using the obtained artifacts; and
provide the primary workspace that has been deployed with the application for use by the user.

19. The hardware memory device of claim 17, wherein the instructions are further executed to:
detect that an attempt to deploy the application has been performed on the primary workspace;
determine whether the primary workspace is locked from being deployed with any new applications;
when the primary workspace has been determined to be locked, inhibit the application from being deployed on the primary workspace.

20. The hardware memory device of claim 19, wherein the instructions are further executed to:
when the primary workspace is not locked from being deployed with new applications, send a request to approve deployment of the application to a workspace orchestrator that is executed to monitor one or more activities of the application for a specified period of time, and approve the application based on the monitored activities.
